(19) United States
(12) Patent Application Publication
(10) Pub. No.: US 2007/0109443 A1
(43) Pub. Date: May 17, 2007

(54) Method and circuit for creating a multimedia summary of a stream of audiovisual data

(75) Inventors: Mauro Barbieri, Eindhoven (NL); Gerhardus Engbertus Mekenkamp, Eindhoven (NL); Benoit Pierre Gerard Huet, Juan Les Pins (FR); Bernard Merialdo, Valbonne (FR)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,451

(22) PCT Filed: Dec. 7, 2004
(86) PCT No.: PCT/IB04/52695

§ 371 Date: Jun. 14, 2006

(30) Foreign Application Priority Data
Dec. 18, 2003 (EP) 03104799.6

(51) Int. Cl. H04N 7/16; H04N 7/00; H04N 7/04; H04N 11/00; H04N 7/173

(52) U.S. Cl. 348/468; 348/469; 725/135; 725/136; 725/88

(57) ABSTRACT

As the amount of audiovisual data that can be received by consumers increases rapidly, there is an increasing need for proper summarisation of audiovisual data like films. Thereto, the invention provides a method of creating a multimedia summary of a stream of audiovisual data like a film. First, a textual summary is retrieved (204). Next, the stream of audiovisual data is segmented (208) and information is extracted from the stream of audiovisual data (210) and the textual summary (206). Finally, segments are selected (212) that carry information matching information carried by the textual summary. Summaries of films and series are abundantly available on the internet and are made by and for devotees, providing a reliable seed for creating a multimedia summary.

The invention relates to a method of creating a multimedia summary of a stream of audiovisual data.

The invention also relates to a circuit for creating a multimedia summary of a steam of audiovisual data. The invention further relates to an apparatus for processing audiovisual data comprising such circuit.

Also, the invention relates to a computer programme product comprising code to programme a processing unit.

Furthermore, the invention relates to a data carrier carrying such computer programme product.

It has been reported over a longer time that the amount of storage available to consumers and the amount of storage used by consumers is increasing. Also the amount of content presented to and available to consumers is ever growing. To provide a proper overview over all content that has been stored by or for a consumer, proper summaries are indispensable, especially for streams of audiovisual data like films.

It is undoable for a consumer to personally summarise every film that is available to him or her. Therefore, it is highly desired to automate this process of summarising a film.

Patent application US 2002/0083471 discloses a system and method for providing a multimedia summary of a video programme. The process of creating a multimedia summary starts from automatically creating a text summary according to the method disclosed in WO 02/041634. Although automatically creating a text summary requires no user interaction, it requires a lot of processing power and therefore expensive circuitry. Furthermore, it is prone to failure because of selection of wrong parts of the video programme. Reason for this is that a circuit for automatically creating a textual summary works according to a couple of rules that may not be applicable to every video programme.

It is an object of the invention to provide a method and circuit for creating a multimedia summary that requires less processing power. To achieve this object, the invention provides a method of creating a multimedia summary of a stream of audiovisual data, comprising the steps of: obtaining a ready-made textual summary of the stream of audiovisual data from an external source; analysing the textual summary to extract information; segmenting and analysing the stream of audio-visual data to extract information; selecting segments from the stream of audiovisual data comprising information matching the information extracted from the textual summary; and combining the selected segments thus forming a multimedia summary.

The invention has been built on the recognition that a lot of databases are available with ready-made textual summaries of video programmes like films and series. Circuits for retrieving these textual summaries via e.g. the internet are abundantly available at a very low price and require a minimum of processing power. Furthermore, the textual summaries can usually be obtained for free.

Furthermore, these summaries are often made by film critics, film devotees or devotees of a series, who know the film and the genre and who know what the highlights of the film or series episode are. In this way, dedicated mental rules are used to set up a textual summary. In this way, a more accurate textual summary is provided than with a circuit applying rules that are almost primitive compared to rules used by the human brain.

In an embodiment of the method according to the invention, the stream of audiovisual data comprises a sub-stream carrying subtitles corresponding to the stream of audiovisual data; and the information extracted from the stream of audiovisual data is extracted from the stream of audio-visual data by analysing subtitles.

An advantage of this embodiment is that subtitles are easy to extract, as they do not have to be extracted from other video data like e.g. the film to summarise.

In another embodiment of the method according to the invention, the information extracted from the textual summary are keywords.

An advantage of this embodiment is that words (as available in the sub-stream) are easy to process, as they can be converted to alphanumeric data and be processed as such.

In a further embodiment of the method according to the invention, the information extracted from the textual summary is extended with information related to the information extracted from the textual summary.

An advantage of this embodiment is that short textual summaries may provide in this way more information or more detailed information. Especially summaries provided by teletext are rather small, as they usually have to fit on one page. By extending the information extracted from this summary, additional information is available for searching for matching segments in the stream of audiovisual data to summarise.

In yet another embodiment of the method according to the invention, the segments are combined at the moment the multimedia summary is played back.

An advantage of this embodiment is that no large amount of additional storage space is required for storing the full multimedia summary, as segments can be played back from the original stream of audiovisual data. The set up of the multimedia summary may be done off-line, prior to playback of the multimedia summary. The result may be a playlist with references to the original stream of audiovisual data to summarise.

The circuit for creating a multimedia summary of a steam of audiovisual data according to the invention comprises a communication unit for obtaining a ready-made textual summary of the stream of audiovisual data from an external source; and a processing unit conceived to: analyse the textual summary to extract information; segment and analysing the stream of audio-visual data to extract information; select segments from the stream of audiovisual data comprising information matching the information extracted from the textual summary; and combine the selected segments thus forming a multimedia summary.

The apparatus for processing audiovisual data according to the invention such a circuit.

The computer programme product according to the invention comprises code to programme a processing unit to perform the method according to the invention.

The data carrier carrying a computer programme product according to the invention carries such a computer programme product.

Embodiments of the invention will now be described in more detail by means of FIGS., wherein:

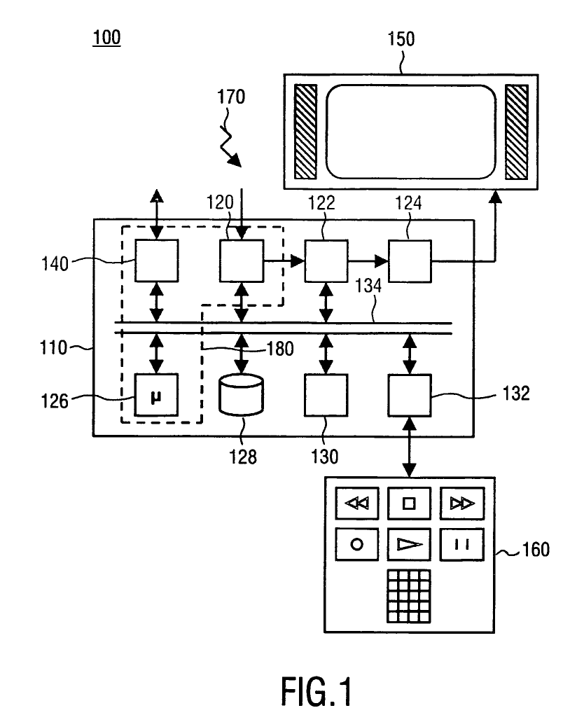

FIG. 1 shows an embodiment of the apparatus according to the invention;

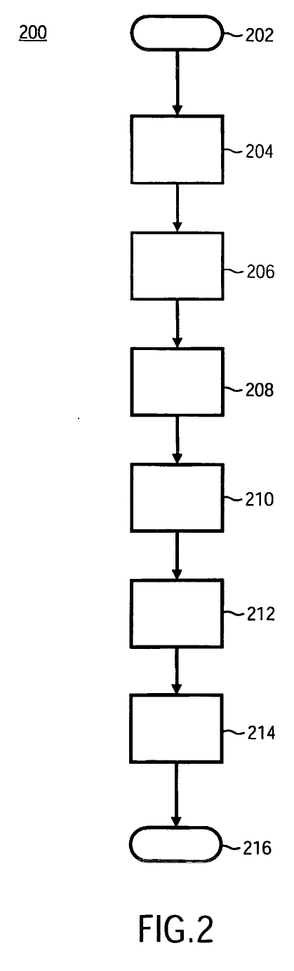

FIG. 2 shows a flowchart depicting an embodiment of the method according to the invention; and

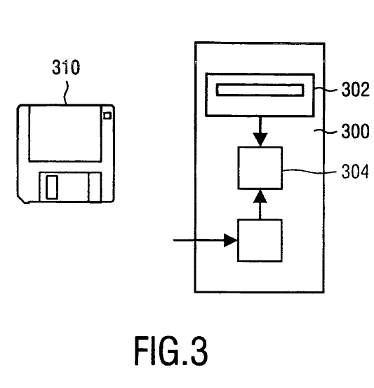

FIG. 3 shows an embodiment of the data carrier according to the invention.

FIG. 1 shows a consumer electronics system 100 comprising a video recorder 110 as an embodiment of the apparatus according to the invention, a TV-set 150 and a control device 160. The video recorder 110 is arranged to receive and record streams of audio-visual data and interactive applications associated with those streams of audio-visual data carried by a signal 170.

To this end, the video recorder 110 comprises a receiver 120 for receiving the signal 170, a de-multiplexer 122, a video processor 124, a central processing unit like a micro-processor 126 for controlling components comprised by the video recorder 110, a harddisk drive 128 as a storage device, a programme code memory 130, a user command receiver 132 for receiving signal from the control device 160 and a central bus 134 for connecting components comprised by the video recorder 110.

The video recorder further comprises a network interface unit 140 for connecting to a network like the internet or a LAN. The network interface unit 140 may be embodied as an analogue modem, an ISDN, DSL or cable modem or a UTP/Ethernet/TCP-IP network interface.

The receiver 120 is arranged to tune in to a broadcast (audio or video) channel and derive data of that broadcast channel from the signal 170. The signal 170 can be received by any known method; cable, terrestrial; satellite, broadband network connection or any other 20 method of distributing audiovisual data. The signal 170 can even be derived from the output of another consumer electronics apparatus. The receiver 120 outputs a baseband signal that carries at least one stream of audiovisual data.

The de-multiplexer 122 is arranged to de-multiplex audiovisual data from other data that may be comprised in the baseband signal outputted by the receiver 120. The video processor 124 is arranged to render audiovisual data outputted by the de-multiplexer 122 in a way that is can be rendered by the TV-set 150. The output can be provided in various analogue formats as SECAM and PAL or digital formats.

Data stored in the programme code memory 130 enables the microprocessor 126 to execute the method according to the invention. The programme code memory 130 may be embodied as a Flash EEPROM, a ROM, an optical disk or any other type of data carrying medium.

The storage device may also be embodied as an optical disk drive like a DVD or Blu-Ray drive and is adapted to store content that is received by either the receiver 120 or the network interface unit 140 for future reproduction on the TV-set 150 or for further dissemination via the network interface unit 140. The content may be processed prior to storage.

To provide a user of the video recorder 110 with a good overview of all data stored in the harddisk drive 128, the microprocessor 126 creates summaries of streams of audiovisual data like films, TV programmes or other stored in the harddisk drive 128 or being received by the receiver 140. This is done either automatically or has to be initiated by the user.

FIG. 2 shows a flowchart 200 depicting an embodiment of the method according to the invention of creating a summary of a stream of audiovisual data. The process steps the various blocks are provided in Table 1 below. The process will be described in conjunction with FIG. 1.

TABLE 1

| Reference | |
|---|---|
| no. | Process step |
| 202 | Initiate summary process |
| 204 | Retrieve ready-made textual summary |
| 206 | Analyse retrieved summary |
| 208 | Segment stream to summarise |
| 210 | Analyse segments of stream to summarise |
| 212 | Select segments with information matching information |
| | extracted from textual summary |
| 214 | Combine selected segments |
| 216 | Return summary |

In a process step 202, the process is initiated, either automatically (by an agent run by the microprocessor 126) or by a user activity, like operating the control device 160.

Subsequently, in a process step 204, a ready-made textual summary of the stream to summarise is retrieved. Summaries of films are available at a lot of places, for example at the internet at http://www.cinema.nl. But also teletext and electronic programme guides (EPGs) provide textual summaries of films and other programmes like series. Especially with respect to soap operas, summaries provide the full plot after episodes have been broadcasted.

In an advantageous embodiment, the summary is retrieved from an internet server by the network interface unit 140. In another embodiment of the invention, the summary is retrieved from teletext data, which is multiplexed in a broadcasted signal and derived from the broadcasted signal in the de-multiplexer 122. For analogue television signals, teletext data is multiplexed in the vertical blanking interval. In case of digital television, teletext data can be provided in a separate stream with a stream of audiovisual data. Teletext data may also be available via the internet at for example http://teletekst.nos.nl/ and can be retrieved by the network interface unit 140.

Although teletext data and EPG data is in a lot of cases received with a stream of audiovisual data and is therefore de facto available in the video recorder 110, it is nevertheless within the context of this application regarded as being retrieved from an external source, as textual summaries retrieved by these means are generated separately from creating the stream of audiovisual data (i.e. for example the shooting of a film).

In yet a further embodiment of the invention, the summary is obtained from an electronic programme guide. This programme guide can be obtained in the same way as teletext data is retrieved; from the broadcasted signal or from the internet.

A major advantage of obtaining a summary in this way is that no summary has to be made from the stream of audio-visual data to summarise, but that it is already available.

Having retrieved the summary, the summary is analysed in a step 206 to extract information. In a preferred embodiment, keywords are extracted from the summary. These keywords can be verbs, nouns or adjectives that occur more than once or that occur in the title of the e.g. film.

In a further embodiment, the information extraction process searches for words related to the keywords extracted from the textual summary. The related words may be synonyms, but one could also think of other relations like the way “fax” is related to “telephone” and “car” is related to “driving”. The information related to the extracted information is in one embodiment retrieved from an external database using the network interface unit 140. In another embodiment, a database for searching additional related information is stored in the harddisk drive 128.

The database may also comprise words not to be regarded as keywords. An example of this are all conjugates of “to be” or other very frequently used verbs.

Subsequently, the stream of audiovisual data is segmented in a process step 208 using known methods as disclosed in application WO02/093929 of the same applicant.

Having segmented the multimedia data object, the segments are analysed to extract information in a process step 210. Various embodiments of the invention are proposed for extracting the information from the segments. When the multimedia data object is a film and the film is provided with subtitles in the film itself, subtitles can be extracted from the other video data and the subtitles can be read using an OCR algorithm.

When subtitles are provided in an alphanumeric format as additional data like teletext or closed captioning, information can be extracted automatically in an easy way.

An intermediate option of the two options discussed in the previous paragraph is also possible. On a DVD, subtitles can be provided by the content provider in a separate stream in a graphical format. To extract information, the subtitles can be easily converted to alphanumeric characters, as they do not have to be extracted from the video data in a stream of audiovisual data for which the subtitles are intended.

In another embodiment of the invention, speech of characters in a film is extracted using speech recognition algorithms. Although this kind of processing requires a lot of processing power, it is expected that processing power of microprocessors will increase further over the coming years. This will allow speech recognition on the fly using cheap commodity microprocessors.

Like with extracting data from the summary in the process step 206, nouns, verbs and/or adjectives are extracted from the subtitles or converted speech text.

Besides text, also other information can be extracted from the stream of audiovisual data, like explosions, action scenes, dialogues and faces of main characters (by means of face recognition).

When the stream of audiovisual data has been segmented and information has been extracted from the textual summary and the stream of audiovisual data, segments for the multimedia summary are selected in a process step 212. This is being done by analysing the information extracted from the textual summary and searching for segments that comprise matching information. In one embodiment of the invention, a segment is selected for the multimedia summary when it comprises at least one keyword comprised by the information extracted from the textual summary.

In a further embodiment of the invention, a segment is selected for the multimedia summary when it comprises a combination of related keywords like “police” and “arrest” or “Netherlands” and “wooden shoe”. combinations like this are also regarded as a match between words comprised by the information extracted from the stream of audiovisual data and the information extracted from the textual summary.

Also segments carrying other information than (spoken) text that may be important for understanding the plot of the story represented by the stream of audiovisual data can be included in the summary. Examples for this are segments with action scenes and explosions.

In an embodiment of the invention, besides the information carried by a segment, also other requirements have to be fulfilled by a scene for selection in the multimedia summary. Such requirements are the length of the scene and the location of the various scenes, as it will in most cases be desirable to have segments selected for the summary from over the whole length of the stream of audiovisual data and not have the case that 90% of the selected scenes are from the first 10% of the stream.

After appropriate segments of the stream of audiovisual data have been selected, the segments are combined in a new stream of audiovisual data, thus forming a multimedia summary of the original stream of audiovisual data of which a summary had to be made. This is done in a process step 214. Preferably, the segments are combined in the order in which they appear in the original stream of audiovisual data.

In another embodiment of the invention, however, the segments are combined in the order in which information comprised in the segments occurs in the textual summary. In yet another embodiment of the invention, the segments are ordered in the multimedia summary in the temporal order. This means that when the original stream of audiovisual data comprises e.g. flash-back of a character in a film, the flashbacks are put in the multimedia summary first, followed by other segments.

In again another embodiment of the invention, the method returns a playlist with pointers to scenes in the original stream of audiovisual data. An advantage of this embodiment is that no separate stream has to be stored for the multimedia summary.

Finally, the multimedia summary is returned in a process step 216. The multimedia summary may be stored in the harddisk drive 128.

A person skilled in the art will appreciate that the various process steps of the process depicted by the flowchart 200 do not necessarily have to be performed in the order as presented. For example, The summary can also be retrieved after the steam of audiovisual data has been segmented and the information has been extracted there from. Also, various steps can be executed simultaneously.

It will be apparent to a person skilled in the art that various variations modifications can be applied to the embodiments presented in the description above. Also, features of the various embodiments can be permutated, without departing from the scope of the invention.

For example, instead of extending the information extracted from the textual summary, also the information extracted from the stream of audiovisual data can be extended or information extracted from both information sources is extended.

Furthermore, although the embodiments of the method according to the invention have been presented as being mainly executed by a single processing unit, the microprocessor 126 (FIG. 1) and for a lesser extent by the receiver 120 (FIG. 1) and the network interface unit 140 (FIG. 1) (all three forming a circuit 180 as an embodiment of the circuit according to the invention), other embodiments of the invention are possible wherein on or more separate steps are executed by separate components like dedicated circuits as ASICs.

The invention can be embodied as a computer programme product, enabling a general purpose computer like the personal computer 300 as shown in FIG. 3 to carry out the method according to the invention.

FIG. 3 also shows a data carrier 310 comprising data to program the personal computer 300 to perform the method according to the invention.

To this, the data carrier 30 is inserted in a disk drive 302 comprised by the personal computer 300. The disk drive 302 retrieves data from the data carrier 310 and transfers it to the microprocessor 304 to program the microprocessor 304. subsequently, the programmed microprocessor 304 carries out the method according to the invention.

The personal computer 300 comprises a communication unit 306 to obtain a textual summary of a stream of audiovisual data to summarise. The communication unit 306 can be embodied as an analogue, cable or DSL modem, as a network interface (UTP, Ethernet, TCP-IP) or any other type of communication unit known to a person skilled in the art.

Summarised, the invention relates to the following:

As the amount of audiovisual data that can be received by consumers increases rapidly, there is an increasing need for proper summarisation of audiovisual data like films. Thereto, the invention provides a method of creating a multimedia summary of a stream of audiovisual data like a film. First, a textual summary is retrieved (204). Next, the stream of audiovisual data is segmented (208) and information is extracted from the stream of audiovisual data (210) and the textual summary (206). Finally, segments are selected (212) that carry information matching information carried by the textual summary. Summaries of films and series are abundantly available on the internet and are made by and for devotees, providing a reliable seed for creating a multimedia summary.

1. Method of creating a multimedia summary of a stream of audiovisual data, comprising the steps of:
a) obtaining (204) a ready-made textual summary of the stream of audiovisual data from an external source;
b) analysing (206) the textual summary to extract information;
c) segmenting (208) and analysing (210) the stream of audio-visual data to extract information;
d) selecting (212) segments from the stream of audiovisual data comprising information matching the information extracted from the textual summary; and
e) combining (214) the selected segments thus forming a multimedia summary.

2. Method according to claim 1, wherein the external source is at least one of the following:
a) Teletext;
b) Electronic Programme Guide; or
c) internet server.

3. Method according to claim 1, wherein
a) the stream of audiovisual data comprises a sub-stream carrying subtitles corresponding to the stream of audiovisual data; and
b) the information extracted from the stream of audiovisual data is extracted from the stream of audio-visual data by analysing subtitles.

4. Method according to claim 3, wherein the sub-stream carries:
a) Closed Captioning data;
b) Teletext subtitle data; and/or
c) subtitles in a graphic format.

5. Method according to claim 1, wherein the information extracted from the textual summary are keywords.

6. Method according to claim 5, wherein the keywords are the nouns, adjectives and/or verbs comprised by the textual summary.

7. Method according to claim 1, wherein the information extracted from the textual summary is extended with information related to the information extracted from the textual summary.

8. Method according to claim 6, wherein the information extracted from the textual summary are nouns, adjectives and/or verbs and the extracted information is extended with further nouns, adjectives and/or verbs related to the nouns extracted from the textual summary.

9. Method according to claim 7, wherein the further nouns, adjectives and/or verbs are synonyms of the nouns, adjectives and/or verbs extracted from the textual summary.

10. Method according to claim 5, wherein:
a) the stream of audiovisual data comprises a sub-stream carrying subtitles; and
b) the information is extracted from the stream of audio-visual data by analysing subtitles; and
c) the step of selecting segments from the stream of audiovisual data comprising information matching the information extracted from the textual summary comprises the step of selecting at least one segment in which the subtitles comprise at least one keyword.

11. Method according to claim 1, wherein the information extracted from the stream of audiovisual data and the textual summary comprises words and a segment of the stream of audiovisual data is selected when at least one first word extracted from the stream of audiovisual data and at least one second word extracted from the textual summary match.

12. Method according to claim 1, wherein the segments are combined at the moment the multimedia summary is played back.

13. Circuit (180) for creating a multimedia summary of a steam of audiovisual data, comprising:
a) a communication unit (140, 120) for obtaining a ready-made textual summary of the stream of audiovisual data from an external source; and
b) a processing unit (126) conceived to:
i.) analyse the textual summary to extract information;
ii.) segment and analysing the stream of audio-visual data to extract information;
iii.) select segments from the stream of audiovisual data comprising information matching the information extracted from the textual summary; and
iv.) combine the selected segments thus forming a multimedia summary.

14. Apparatus (110) for processing audiovisual data, comprising the circuit according to claim 10.

15. Computer programme product comprising code to programme a processing unit (126, 304) to perform the method according to claim 1.

16. Data carrier (130, 310) carrying the computer programme product according to claim 13.
